(19) United States
(12) Patent Application Publication
(10) Pub. No.: US 2009/0223154 A1
(43) Pub. Date: Sep. 10, 2009

(54) Flooring System

(76) Inventor: Paul Anthony Anderson, Victoria (AU)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/087,722

(22) PCT Filed: Mar. 14, 2007
(86) PCT No.: PCT/AU2007/000644

§ 371 Date: May 19, 2009

(30) Foreign Application Priority Data
May 15, 2006 (AU) 2006902585

(51) Int. Cl. E04F 15/00; E04C 2/20; B44F 9/02; E04G 23/02

(52) U.S. Cl. 52/309.1; 52/413; 52/313; 52/747.1

(57) ABSTRACT

A floor covering system is described comprising at least two layers in which one of the layers is a base layer made from a multitude of interlocking base elements having a multitude of raised hollow tubes with tapering sides on the upper surface and the other layer is a top covering layer, preferably made from a vinyl material, preferably having a simulated wooden appearance, to which is adhered a fabric backing layer having a multitude of loops. In use the base elements are placed on a floor with the tubes uppermost and the top covering layer with the loops lowermost placed on the base elements such that the loops engage around the tapering side surfaces of the tubes to releasably attach the two layers together so that when required, such as for example, when the top covering layer is worn, the top covering layer can be removed from the base layer without having to also remove the base layer thereby allowing the floor covering layer to be readily replaced with a new floor covering layer.

### FIELD OF THE INVENTION

The present invention relates to flooring systems having two or more layers in which at least two of the layers are releasably securable to each other allowing ready separation of those two layers when it is necessary to replace one of the layers.

In one embodiment the present invention relates to a flooring system having at least two layers in which at least one layer, being the top layer, is a floor covering layer, such as for example, a vinyl layer or a layer made from a vinyl material or containing a vinyl material which layer can be readily replaced without having replace the remaining layer or layers or to remove the remaining layer or layers from the substrate of the floor which are one or more base layers or underlayers located upon a floor substrate thereby enabling ready replacement of the one removable floor covering layer when worn or damaged or for any other reason.

The present invention finds particular application as a vinyl floor covering system having the appearance of a simulated floor covering including having the appearance of timber, ceramic tiles, or like surface treatments, for use in domestic, industrial or commercial flooring systems having a top floor covering layer made from vinyl material in which the top vinyl layer is releasably securable to an underlying base layer by releasably securable fastening elements so that when it is desired to replace the top vinyl layer, such as for example, when worn, it is necessary only to separate the top vinyl layer from the underlying base layer or underlayer to replace the vinyl layer with a fresh vinyl layer since the underlying layer can remain in place either located upon or secured to the substrate of the floor thereby obviating the need to replace the base layer or to treat the floor or substrate over which the floor covering system is located by the floor requiring minimal preparation only thus allowing the floor covering to be replaced or rejuvenated at low cost, and/or in a quicker time.

Although the present invention will be described with particular reference to one form of a vinyl flooring system having a floor covering layer and attached fabric underlying layer laid in close fitting adjacent strips, it is to be noted that the present invention is not limited to the described embodiment but rather the scope of the present invention is more extensive so as to include other forms and arrangements of the flooring system, other forms and arrangements of each of the layers making up the flooring system, including the base layer and the floor covering layer, other forms and arrangements of the releasable fastening elements securing the various layers together, and the use of the systems in a variety of different applications other than the particular application described.

### BACKGROUND OF THE INVENTION

Commercial buildings are usually provided with a concrete floor or similar rigid substrate, including sub-floors, that serve as a floor or floor substrate which requires covering by a suitable floor covering or flooring. In the past, carpet has been one example of a suitable flooring system that has been used to cover concrete floors, particularly in large commercial establishments such as for example, retail establishments such as department stores, shopping centres, and in accommodation and eating establishments such as hotels, restaurants, offices and other large commercial or industrial buildings. Carpet has also been used in domestic applications for the floor covering of rooms in dwellings and the like. Owing to the large volume of traffic to which the existing flooring system of department shops or other commercial establishments are subjected, the flooring systems wear, sometimes quickly, so that eventually replacement of the floor covering is required. Even when using heavy duty floor covering and premium quality materials for the floor covering, it is estimated that the flooring of a large retail establishment such as a department store or similar could have a short working life. Accordingly, regular periodic replacement of the floor covering or at least refurbishment of the floor covering is required from time to time which is expensive and time consuming.

However, some existing floor covering systems are not well suited or adapted to regular periodic replacement as such systems are usually firmly fixed in place onto the floor or floor substrate owing to the nature and construction of the systems used and are not meant to be removed or rejuvenated. Furthermore, such fixed flooring systems have a number of problems associated with them when being replaced or relaid.

One problem with some existing flooring systems is that different types or styles of floor covering are required in different circumstances, such as for example, perhaps due to changes in the use of the building or part of the building, such as for example, the relocation of a department from one location or area to another location or area, or the reallocation of one area of the building to an entirely different purpose or use requiring a different floor covering. Another reason for periodic change is to accommodate changes in fashion of the floor covering including changing from one type of material to a different type of material in accordance with the expectation of customers, such as for example, from a carpet floor covering to a timber floor covering. In the past, carpet flooring was desirable and was extensively used in retail shops. However, with changing fashion and use requirements wooden or timber flooring is becoming more fashionable to use or is increasingly required for use, such as for example, on health and hygiene grounds as the wooden floor presents an hygienic surface that is easier to clean and polish and thus maintain in an “as new” condition than is carpet which is prone to the accumulation of dirt and dust particles and the like within the fibres of the carpet. In particular, at the moment, timber flooring comprising wooden boards, planks, parquetry or similar are much in demand. However, timber floors are prohibitively expensive, less durable and require high maintenance and the like and are not in general use in the retail environment apart from use in upmarket or high-end retail establishments. Instead, simulated wooden flooring is often used to provide the look, ambiance and atmosphere of wooden or timber floors. One example of the simulated wooden flooring is vinyl, particularly vinyl in strips simulating individual planks or wooden boards. However, the use of individual strips of simulated wooden flooring pieces suffers from a number of problems. The individual strips of simulated flooring need to be placed together so that there cannot be any movement of the individual pieces either overall or with respect to one another. If individual pieces move, cracks or gaps appear between the individual pieces which are potentially dangerous and unsightly.

Additionally, moisture can permeate through the floor such as concrete floors, particularly if the sealing membrane located on the concrete floor has been omitted or has deteriorated to an extent of having gaps, tears or similar therein. As the moisture permeates through the concrete floor, it can dissolve, soften or modify the glue on the underside of the simulated flooring, particularly along the edges and around the corners of the individual strips, often resulting in lifting of the edges and/or corners revealing gaps, cracks or the like often appearing between the individual pieces. Not only are the lifted edges and corners unsightly but also they can be dangerous to walk on because of the potential for people to trip over the exposed edges or corners of the individual strips which could lead to injury.

Additionally, in many cases moisture can permeate through the floor, particularly concrete floors, and more particularly if a sealing membrane or similar has been omitted during construction of the concrete floor or if the membrane has deteriorated or become torn or holed through use over time. As the moisture permeates through the concrete floor it can dissolve the glue on the underside of the vinyl floor covering resulting in the floor covering having a tendency to lift and separate from the underlying floor structure owing to hydrostatic pressure, chemical or physical modification of the imposed polymers or the like, which can lift the vinyl flooring entirely off the floor or floor substrate in extreme cases thereby loosening the individual strips which are free to move. The movement of the individual strips again lead to the floor covering having a poor appearance and creating the potential for injury to a person tripping on the strips which are now not adequately secured to the floor. To prevent the migration of moisture permeating through the concrete floor, a barrier layer needs to be applied to the concrete. Sometimes it takes days for the barrier layer to cure completely or to cure at least sufficiently for application of a floor covering to the floor or floor substrate. This adds to the expense of laying or rejuvenating the floor covering system and to the time taken to lay the floor or to refurbish the floor.

Another problem of simulated wooden flooring is that the flooring tends to conform to the shape of the underlying floor structure by taking the shape of the substrate immediately beneath the simulated flooring. If the substrate has a high spot, a corresponding high spot is formed in the floor covering, or if the floor has a depression, a corresponding depression is formed in the floor covering. Any imperfection or irregularity in the surface of the floor such as a ridge or depression is visible in the floor covering after a very short period of time as the simulated flooring is flattened against the floor during use by foot traffic of people walking on the floor so that the surface imperfections and irregularities appear on the floor covering. To remove the surface irregularities it is necessary to treat or prepare either the floor or the underlay layer to smooth their surface, both of which add to the expense of replacing the floor covering.

Additionally, it is usual to glue the floor covering layer, such as the vinyl floor covering directly to either the floor, a subfloor, a floor substrate or to an underlay layer located between the floor and floor covering by adhering the underside of the floor covering layer directly to the floor or underlay. When it is time to renew the floor covering, the floor covering layer is usually pulled up in an attempt to separate the floor covering layer from the underlying layer whether it be the floor itself or an underlay layer. Often part of the underlay or floor is pulled up along with the floor covering as the underlay layer tears apart owing to the strength of the bond between the underlay layer and floor covering layer thus leaving an uneven surface on the floor, floor substrate or subfloor which is a combination of floor, underlay layer, floor covering layer all having different heights leading to the floor surface being uneven by having ridges and depressions located over the entire surface of the floor. In this event the underlay then needs to be fully removed from the floor in order to provide a smooth surface. Also, often the underlay layer requires replacement and the floor may also require treatment to make it smooth such as by grinding, sanding or other treatment to provide a smooth surface on which to lay the new floor covering. Therefore, in previously available flooring systems using simulated flooring, not only is the top or covering layer required to be replaced when worn or the like but owing to the construction of the floor covering system as a whole particularly the undersurface of the vinyl layer, the underlay layer also required replacing, and sometimes the flooring itself needed smoothing, sanding, grinding or the like. All of which take time to remediate through having to provide workmen to work on the floor, sometimes for days before an acceptably smooth surface in good condition is made available upon which to lay the new floor covering layer. Accordingly, there is a need for a simulated flooring system, particularly a simulated wooden flooring, having a floor covering layer which is easier and more cost effective to replace.

Many, if not all of the previously mentioned problems have arisen from the backing surface of the top layer or floor covering layer requiring the use of an adhesive or other more or less permanent adhesion system to secure the undersurface or backing of the layer to the underlayer or base layer because of the almost permanent bonding of the top layer to the base layer which made it difficult to remove the top layer without also removing the base layer, at least in part.

Therefore, it is an aim of the present invention to provide a readily replaceable floor covering layer made from a suitable floor covering material, such as for example, vinyl material, particularly a vinyl material having a simulated appearance that is easier to replace than existing floor covering systems by providing a modified backing layer or undersurface on the replaceable floor covering layer.

### SUMMARY OF THE INVENTION

According to one aspect of the present invention there is provided a floor covering system capable of covering a floor or floor substrate of a building, said floor covering system comprising a base layer having a lower surface capable of being located upon the floor, floor substrate or subfloor or onto an intermediate layer and having an upper surface provided with one or more first fastening elements, and a covering layer having a lower surface provided with one or more second fastening elements, said first and second fastening elements being complementary to one another to allow the covering layer to be releasably secured to the base layer by the interaction of the first and second fastening elements, wherein when the covering layer is to be replaced the covering layer is readily removable from the base layer by separating the first and second fastening elements from each other thereby releasing the covering layer from the base layer whilst the base layer remains in situ on the floor, floor substrate, subfloor or intermediate layer.

According to another aspect of the present invention, there is provided a floor covering system having a simulated appearance made at least in part from a vinyl material capable of covering a floor or floor substrate of a building to provide a simulated floor having the appearance of individual elements of a floor, said floor covering system comprising a base layer having a lower surface capable of being located upon or secured to the floor substrate or to an intermediate layer located between the floor and the base layer and having an upper surface provided with one part of a fastening system, and a covering layer having a lower surface provided with another part of the fastening system, said one part of the fastening system and the other part of the fastening system being complementary to each other to allow the floor covering layer and base layer to be releasably secured to each other, said base layer being locatable between the floor and the covering layer to provide an underlay for the covering layer which underlay is substantially smooth and regular so that when the floor covering layer needs replacement the covering layer can be releasably removed from the base layer by separating the releasably securable fastening elements from each other without the base layer being removed from the floor substrate.

According to another aspect of the present invention there is provided a removable floor covering layer comprising a first part in the form of a vinyl layer or a layer containing vinyl or a vinyl look-a-like layer or a vinyl substitute layer forming a top surface of the floor covering layer and a second part in the from of a backing layer attached, adhered or in intimate contact with the top surface to form the floor covering layer wherein the backing layer is provided with at least one releasably receivable fastening element for releasably securing the floor covering layer to another layer or part of a floor to allow ready removal of the top covering layer from the other layer or floor when the floor covering layer is to be replaced.

According to another aspect of the present invention, there is provided a method of covering a floor including the steps of locating a base layer on the floor or on an intermediate layer located on the floor, said base layer having a lower surface capable of being located upon or securely attached to the floor substrate or intermediate layer, said base layer having an upper surface provided with at least one first fastening element, locating a covering layer having a lower surface provided with at least one second fastening element upon the base layer wherein the first and second fastening elements cooperatively engage with each other to releasably secure the covering layer to the base layer, such that the lower surface of the floor covering layer is releasably fastened to the upper surface of the base layer thereby allowing ready removal of the floor covering layer from the base layer by separating the releasably securable fastening elements from one another.

According to another aspect of the present invention there is provided a method of renovating a floor covering using a floor covering system comprising a base layer and a floor covering layer in which one surface of the base layer is located upon or securely attached to the floor substrate or to an intermediate layer and the other surface of the base layer is releasably securable to a floor covering layer thereby allowing ready replacement of the covering layer to renovate the floor covering wherein the lower surface of the floor covering layer is provided with a multitude of first fastening elements and the upper surface of the base layer is provided with a second set of fastening elements arranged so that the floor covering layer is releasably securable to the base layer.

### BRIEF DESCRIPTION OF THE INVENTION

Typically, the floor covering system of the present invention comprises two, three, four or more individual layers. More typically, the layers are a base layer, a floor covering layer and one or more intermediate layers in which one of the intermediate layers is a backing layer for the floor covering layer. Even more typically, the base layer can comprise two layers in which the first layer is a more or less rigid layer and the second layer is substantially flexible, resilient, fibrous or the like. Even more typically, the floor covering layer can comprise two layers in which the first layer is a top layer providing the appearance of the floor covering and the second layer is the backing layer being essentially resilient, flexible, fibrous or the like. More typically, the floor covering layer is the top layer or top layers or is the top most layer. Even more typically, one of the intermediate layers or the intermediate layer if only one intermediate layer is present can be located between the floor and the base layer. Preferably, the floor covering system has two layers, being a base layer and a top layer or floor covering layer in which the base layer is located directly upon the floor to form a subfloor or similar, and the floor covering layer is the top layer located on the base layer, preferably with the backing layer adhered to the top layer in contact with the base layer.

Alternatively, there are three layers, such as an intermediate layer, typically an intermediate layer between the floor and the base layer.

Typically, the base layer of the present invention is in the form of individual base elements or is modular, such as for example being in the form of plates, tiles, squares, panels, rectangles, hexagons, sheets, hook plates or the like. More typically, the individual base elements are regularly or symmetrically shaped. Even more typically, the individual base elements are locatable in side-by-side and/or in end-to-end relationship with each other. Even more typically, the individual floor elements are interconnected together or are interlockingly connected together to form the base layer or are provided with one or more parts of interlocking elements allowing the individual base elements to be interlocked together to form the base layer by the interlocking elements selectively located along the sides, ends or corners of the base elements cooperatively engaging with one another to retain the base elements in adjacent connected relationship to each other. Typically, the interlocking elements are discs or are disc like or the like.

Typically, one part of the interlocking elements or parts are grooves, rebates, cut-outs, openings, apertures, slots or the like and another part of the interlocking elements are projections, tabs, tags, fingers or similar. More typically, the interlocking elements are located at the corners of the individual base elements. Even more typically, the interlocking elements are in the shape of quadrants, semicircles, quarter circles or other generally curved or arcuate shapes or the like. Even more typically, one or more edges of the individual elements are provided with edge strips, preferably reduced thickness edge strips or the like so that when two adjacent individual base elements are in abutting relationship with each other the reduced thickness edge strips overlie or are superposed one another to allow a smooth substantially continuous base layer to be formed from all of the interconnected base elements laid in side by side relationship to each other and/or in end to end relationship to one another. More typically, each element has two under-hang sides and two over-hang sides allowing the modules to free float and interlock with each other and the interlocking discs. A particularly preferred form of the interlocking elements is a hook plate manufactured by TacFast Systems of Canada under the name “Hook plate”.

Alternatively, the base layer can be substantially continuous in the form of a film, roll, sheet, panel, continuous strip or the like extending continuously from one side of the room or floor to the other side of the room or floor.

In one form, the underside of the interlocking elements can have an ultrasonically welded polyethylene cushion or a textile backing.

In one embodiment, the floor covering layer is in the form of individual cover elements such as plates, tiles, squares, rectangles, elongate strips, simulated timber lengths, sheets, boards, regular polygonal shapes such as hexagons, octagons, triangles or the like. Alternatively, the floor covering layer is continuous or substantially continuous being in the form of a roll, film, sheet, panels or the like.

Typically, the appearance of the floor covering layer is that of a timber floor, a tiled floor, a ceramic tiled floor, a cork floor, a stone floor, a masonry floor or the like. More typically, the appearance of the floor is of separate elements, such as in the form of strips, boards, planks, tiles, squares, paving, blocks, flitches, or the like.

Typically, the individual base elements of the base layer or cover elements of the floor covering layer can be the same or different by being independently flexible, semi-rigid, rigid or the like including combinations thereof in different parts of the flooring system for different purposes. More typically, the base elements or base layer is self supporting or can form a subfloor, false floor, floating floor, or the like. Even more typically, the base elements can be made from plastic materials or other suitable materials, including fibrous materials, natural or synthetic materials, combinations of natural or synthetic materials, woven materials, non woven materials or the like. Typically, the base elements can have an additional layer located on or to the underside of the base element, such as a flexible layer, felt layer, fibrous layer, underlay layer, cushioning layer or the like.

Typically, the floor covering layer is a vinyl flooring material or a vinyl-like flooring material or similar, preferably a vinyl material simulating a wooden or timber floor or a tiled or ceramic or clay floor. Even more particularly, the vinyl flooring is in the form of individual strips representing individual elements of a wooden or timber floor, such as wooden floor boards, wooden planks, timber blocks, parquetry, timber lengths or other timber flooring shapes and the like or representing designs made from timber or timber shapes.

Typically, the floor covering layer is a vinyl layer or a layer containing vinyl or a vinyl look-a-like layer or vinyl substitute layer. More typically, the floor covering layer is a laminated or layered vinyl structure or vinyl look-a-like layer having two or more different layers in which the vinyl layer or vinyl containing layer or vinyl look-a-like layer or vinyl substitute layer is one of the layers, preferably the or one of the top layers or the top most layer. Typically, the floor covering layer includes an additional layer in the form of the backing layer, preferably in the form of a fabric layer or a fabric-like layer or a layer that acts like a fabric layer, or in the form of a fleece. More typically, the fabric layer or fleece is provided with the second fastening elements. Even more typically, the fibres of the fabric layer or fleece are the second fastening elements. Even more typically, the second fastening elements are loops formed from the fibres of the fabric layer. More typically, the fabric is a woven or non woven fabric. Even more typically, the additional fabric layer being the backing layer is adhered to the vinyl layer by a suitable adhesive, or by a suitable welding means, such as for example, ultrasonic welding.

Typically, the tension applied to the fabric layer on adhering to the vinyl layer is matched to the vinyl layer. Even more typically, the fabric layer is stretched prior to or on applying the fabric layer to the vinyl layer. It is to be noted that the amount of tension applied to the fabric backing layer needs controlling so that it matches the vinyl top covering layer since if too much tension is applied to the fabric backing layer, the top covering layer may buckle, ruck up or similar and if the tension is insufficient the fabric backing layer will be too loose so that the fibres forming the loops may not engage the projections of the hook plate sufficiently to retain the two layers securely without there being no unwanted movement.

In some embodiments, there is an intermediate layer between the vinyl layer and the fabric layer. Preferably, fabric layer forms the fastening elements or is provided with fastening elements, typically, releasably securable fastening elements. More preferably, the fabric layer has a plurality of hooks, loops, Velcro or similar fasteners, most preferably a plurality of loops arranged in different random orientations. Typically, the loops are formed from the fibres used to make the fabric layer. Typically, the fabric layer is integral with the vinyl layer and is in intimate contact with the vinyl layer or is separate from the vinyl layer and adhered to the vinyl layer using suitable adhesive, ultrasonic welding or the like. Preferably, the fabric or fabric layer is a polypropylene non-woven based loop fabric incorporating polyethylene barrier film, preferably a polypropylene non-woven and polyethylene film tricot stitched with polyester yarn to provide protruding engagement loops for hook and loop fastening. Typically, the polyester yarn is polyethylene terephthalate (PET). The hooks of the hook plate provide the hooks for reengaging with the loops.

Typically, the fabric covers one entire surface of the vinyl layer, typically the lower surface, or alternatively covers only part of the lower surface of the vinyl layer. More typically, the fabric layer is located around the edges of the strip of vinyl to adhere the vinyl strip securely to the base layer around the edges and at the corners of the vinyl strip. More typically, the fabric is located in regular patterns or random patterns or the like on the under surface of the vinyl layer to secure the vinyl layer to the base layer.

Typically, the base layer is a free floating substrate or sub floor, preferably a modular free floating floor. Typically, the upper structure of the base elements or base layer is provided with fastening elements complementary to the fastening elements of the floor covering layer, preferably projections that are complementary to the loops. The projections or hooks are one example of the first fastening elements. More typically, the fastening elements are projections, preferably in the form of open tubes, preferably open tubes having enlarged heads, flanges, enlargements, hooks or the like for engaging the loops. More typically, the fastening elements are small hook elements that cover more or less the entire surface of the base element or base layer, such as for example, up to many hundreds of thousands of hooks per individual element, preferably about 100,000 to 200,000, more preferably about 130,000 to 180,000 and most preferably about 158,000, hooks per plate. There are about 4 million hooks provided on the base layer surface collectively in about a 9 sq. mt. room or the like.

### BRIEF DESCRIPTION OF THE DRAWINGS

The present invention will now be described by way of non-limiting example with reference to the following drawings in which:

FIG. 1 is a fragmented exploded perspective view of one embodiment of the flooring system of the present invention having a timber look top surface and showing an enlarged view of one form of the second fastening elements provided on the surface of the base layer in more detail;

FIG. 2 is a fragmented exploded perspective view of another form of the flooring system of the present invention showing an enlarged view of one form of the first fastening elements of the top layer and one form of the underneath surface of the base layer in more detail;

FIG. 3 is a vertical cross-section view through one form of the flooring system of the present invention showing the top layer in the form of a vinyl appearance;

FIG. 4 is a vertical cross-section view of another form of the flooring system of the present invention showing the top layer as having a timber appearance;

FIG. 5 is a vertical cross-section view of another form of the flooring system of the present invention showing the top layer as having a ceramic tile appearance; and

FIG. 6 is a vertical cross-section view of another form of the flooring system of the present invention showing the top layer as having a cork tile appearance;

### DETAILED DESCRIPTION OF THE INVENTION

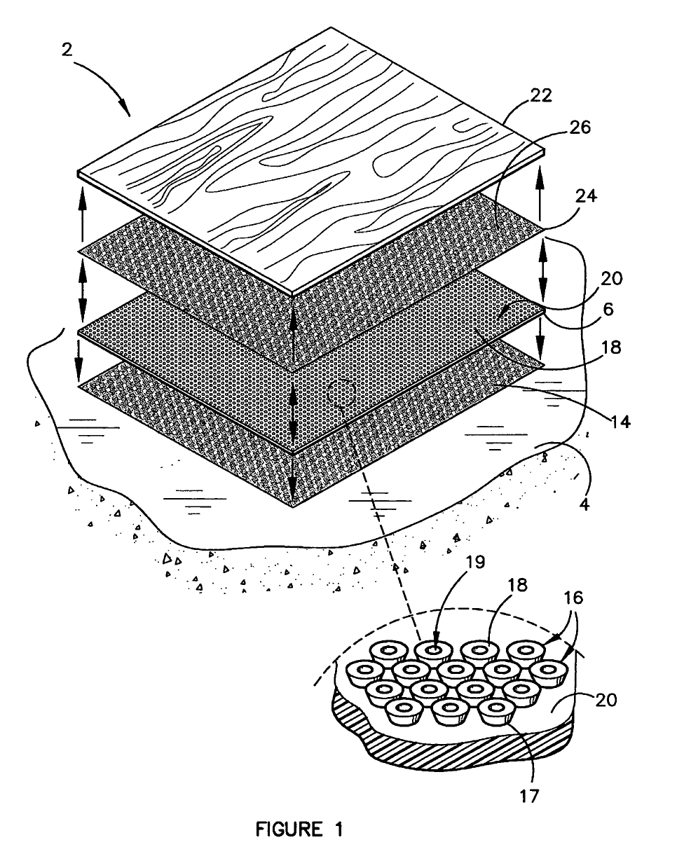

In one embodiment of the floor covering system of the present invention generally denoted as 2 as shown in FIG. 1, there is a concrete floor or floor substrate, generally denoted as 4, upon which it is desired to lay a floor covering system in accordance with the present invention. The floor covering systems includes a base layer 6 in the form of a plurality of plates, preferably rigid plates or semi-rigid plates, and more preferably, hook plates, typically made from a plastics material, such as for example, polycarbonate, polyethylene, polyester, polypropylene, fibrous material or the like which are interlockingly connected together by a suitable interlocking element (not shown) to form a substantially continuous layer over the entire surface of the floor or floor substrate. The plates can be adhered directly to the floor 4 or floor substrate with a suitable adhesive, double sided adhesive tape or by fasteners such as screws, nails, cleats, staples or the like, or can be loosely laid upon the floor surface 4 so as to be free floating. One form of the plates 6 is an interlocking hook plate of the type provided by the Tac-fast Company of Canada. The plates which are square plates of generally about half a metre in length along each side are provided with a generally arcuate cut out or rebate at each corner in the form of a quadrant. Additionally, at each corner is provided a slot in the form of a depression such as a keyway slot or the like. A generally circular interconnecting element in the form of a disc is locatable within the circular opening formed by four adjacent quadrant cut-outs at the corners of the plates when four plates are located in an abutting square arrangement or similar when located in side by side and end to end relationship to each other. The disc is provided with a projection or a combination of a projection and slot for being received in the keyway slots of each of the plates to lock the plates together to form a substantially continuous base layer. The disc is rotatable between a lock position for interlocking the plates together in which the projection of the disc cooperatively engages the key way slot and an unlock position in which the projection is free of the keyway slot thus allowing the plates to be separated to assist in installing and/or removing the plates.

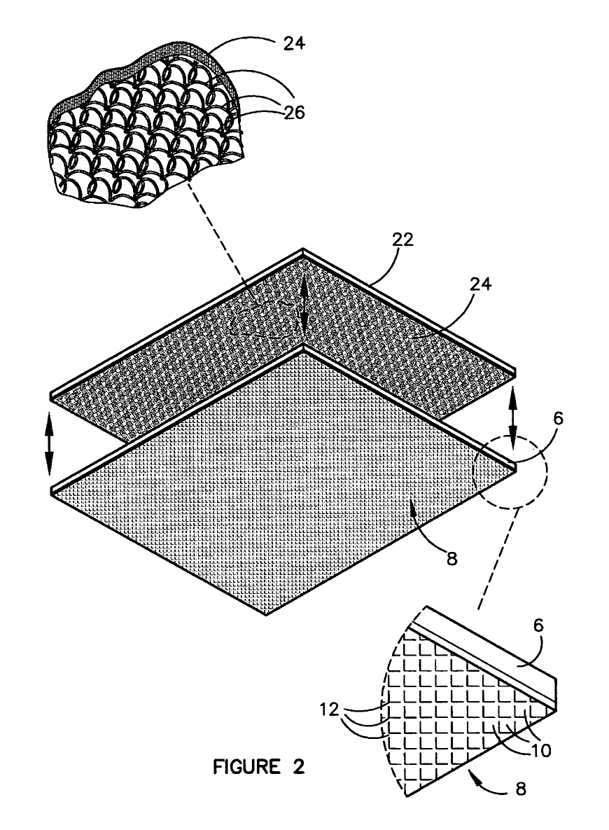

The lower surface 8 in use of each plate 6 is generally smooth or is provided with a surface pattern, such as for example, a plurality of small squares 10 separated by channels 12 forming a grid like pattern of rows and columns, particularly as shown in FIG. 2, for laying on the smooth surface of the concrete floor 4 or floor substrate. In some embodiments an intermediate layer of suitable material, such as for example a textile layer 14, a cementatious floor levelling compound, a hardboard type underlay, a cushioning layer, or other subfloor treatment is provided between the upper surface of the floor 4 and the lower surface of the base layer 6. The intermediate layer can be a separate layer or adhered to the underside of the plates 6 or to the upper surface of the floor 4. If the intermediate layer is a fabric or textile layer 14, it is preferred that the layer be a separate layer in contact with the undersurface of the base layer plate 6 or be loosely adhered to the undersurface of the base layer, such as for example, using a release coating allowing the intermediate layer to be removed without disturbing the intermediate layer.

The upper surface of the plate 6 is provided with a plurality of projections arranged in closely packed or closely spaced apart relationship to each other over almost the entire upper surface of the plate including the edge strips, if provided. In one embodiment the projections are in the form of small hollow tubes 16 or annuli having a centrally located opening 19 and tapering sides 17 or similar, and forming in effect enlarged heads 18 with tapering sides 17 around openings 19 or the like, standing proud of the upper surface 20 of the plate. The hollow tubes 16 are one example of the first fastening elements. Other examples of fastening elements include projections, hooks, Velcro, or similar releasably securing fastenings extending outwardly from the upper surface of plate 6. It is to be noted that any suitable releasably securable fastening elements and/or system can be used to secure the upper surface of the base layer to the undersurface of the floor covering layer. Once the entire base layer is formed upon the concrete floor 4, the remainder of the floor covering system can be located over the base layer.

The floor covering layer will now be described in detail.

One form of the floor covering layer is a multitude of individual strips or lengths of a vinyl flooring material 22, particularly strips in the shape of elongate wooden floor boards, planks, blocks, flitches or similar being substantially elongate having a length very much greater than the width such as for example, in the shape of a traditional timber floor board. Alternative appearances and shapes of the vinyl strips are possible, such as tiles, sheets, panels or the like as well as decorative motives, shapes, symbols or the like. The upper surface of the vinyl strip has the appearance of a timber floor or wooden floor board or other alternative appearance or finish. When all of the individual strips are laid in side by side end to end relationship a substantially continuous floor covering having the appearance of a wooden floor formed from floor boards is formed, in which the individual strips and/or joins between adjacent strips are all about the same level so as to present a smooth appearance or if another alternative appearance is desired, the finish on the top of the vinyl layer can show the alternative appearance.

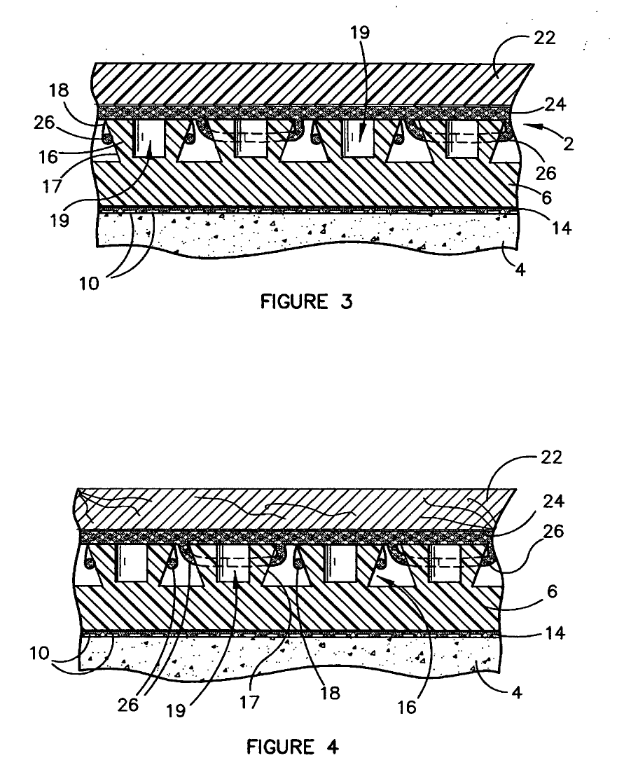

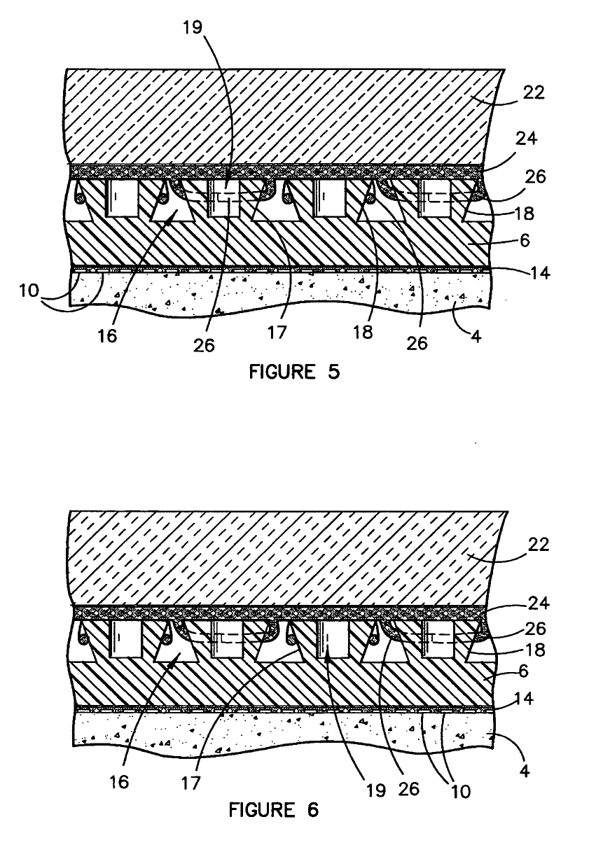

The underneath surface of each vinyl strip, tile or the like is provided with a backing layer in the form of a fabric layer 24 adhered to or glued to or otherwise stuck to or in intimate contact with the under surface of the vinyl layer 22. The fabric backing layer 24 is provided with suitable fastening elements in the form of a plurality of loops 26 designed to cooperatively engage with the enlarged heads 18 of small hollow tubes or hooks 16 on the upper surface 20 of the base elements 6 by the loops 26 being received over the heads and around the walls of the tubes as shown in FIGS. 3 to 6 to dip down towards the base of the projections where the projections stick out of the base element. The loops are one example of the second fastening element. In one embodiment the underneath surface of fabric layer 24 is integral with the simulated wood appearance vinyl layer 22 whereas in other embodiments the fabric layer 24 is separate to the vinyl layer 22 but adhered thereto as the backing layer. In still other embodiments (not shown) an intermediate layer could be located between the upper vinyl layer and the lower fabric layer to impart other characteristics to the flooring or for any other purpose as required. Alternatively, the lower surface of the vinyl layer may be provided with loops or other suitable releasably securable fastening elements complementary to the fastening elements on the upper surface of the base layer, such as for example, by the loops being selectively applied to the vinyl undersurface in a random pattern or similar so that the ends of the loops stick to the vinyl layer and the vinyl part of the loops are free of the vinyl layer to engage with the projections.

The fabric layer is matched to the vinyl layer by being under tension so that the fabric layer when applied to the vinyl layer forms a composite layer having a smooth flat upper and lower surface without deformation, such as without having a tendency to warp, twist, curl, bend, pucker or the like either transversely or longitudinally.

In one embodiment the fabric layer 24 is provided with a plurality of loops 26, Velcro or other elements forming the other set of the fastening elements. Usually, the fastening elements are loops. However, other alternatives are possible. In use the fabric layer 24 comprising loops 26 is located upon the upper layer 20 of the plate 6 having the plurality of tubes 16 so that the loops engage with the hollow tubes by being caught against the tapering sides of the tubes and being retained in place so that the vinyl floor covering layer 22 is releasably secured to the base layer 6 as the hooks or heads 18 of the hollow tubes 16 cooperatively engage the loops 26 of the fabric layer 24 to retain the loops 26 in place between and/or around the heads thereby maintaining the covering layer 22 in place on base layer 6. Further it is to be noted that loops 26 are arranged in multiple orientations so that individual loops can cooperatively engage around the enlarged heads of tubes 16 from different directions and in different orientations to assist in securing the floor covering layer to the base layer so a to prevent movement of the floor covering layer relative to the base layer, particularly lateral movement as well as resisting vertical movement.

It is to be noted that the vinyl floor covering layer 22 can be made from any suitable material and have any desired appearance. However, a preferred appearance is to have a simulated wood finish, ceramic tiles, cork tiles or the like. Further it is to be noted that applying the fabric backing layer to the underside of the vinyl layer provides the improvement and advantage of the present invention since the usual back of a vinyl layer is not provided with any loops or hooks or similar that can cooperatively engage with other complementary structural features.

Use of the floor covering system of the present invention will now be described. If the floor, such as concrete floor 4, is a new floor or in a new condition, the floor will be substantially flat and free of surface irregularities such as ridges or depressions. In this case, the floor requires no further preparation or treatment apart from perhaps cleaning. The base layer comprising the plurality of plates can be located or assembled upon the new floor as a free floating floor or subfloor.

In the event that the existing floor 4 is old or is not sufficiently smooth, the old concrete floor can be prepared or treated such as for example by sanding or grinding to produce a substantially smooth floor. Then plates 6 forming the base layer can be located or assembled on the newly treated floor either loosely or affixed to the floor.

When all of the plates 6 forming the base layer have been laid down to form the free floating floor, the floor covering layer can be placed upon the base layer 6 so that the upwardly directed plurality of hollow tubes 16 on the upper surface 20 of the base layer 6 cooperatively engage with the loops 26 of the fabric layer 24 on the underside of the vinyl layer 22 to secure the vinyl layer 22 to the base layer 6 in a manner that prevents the strips forming the floor covering layer from moving or the edges or corners of the individual strips from lifting. As the floor is substantially smooth and/or the upper surface 20 of the base layer is substantially smooth, there will be no surface imperfections or irregularities shown in the vinyl layer when laid upon the base layer and when flattened against the base layer by repeated walking on the flooring systems.

When it is desired to replace the vinyl layer 22 forming the top most layer of the floor covering system, such as for example, when worn after a number of years of use, the top most floor covering layer 22 can be easily pulled in an upwards direction to be released from the upper structure of the base layer 6 by separating the loops 26 of the fabric layer 24 from the upstanding hollow tubes 16 of the base layer 6 by the loops 26 sliding under tension along the tapering walls 17 of the tubes 16 until the loops stretch or deform sufficiently to slide clear of the top of the tubes 16 thus releasing the loops and allowing the top layer to be removed from the base layer. The base layer can remain in place as the top covering layer is removed thereby still providing a substantially smooth foundation for the new floor covering layer to be located in place. It is then a simple matter to merely relay a replacement floor covering layer comprising a plurality of individual strips upon the base layer. By using the floor covering system of the present invention, the floor covering layer can be readily replaced at a fraction of the cost of replacing the floor covering of conventional flooring systems since the firm foundation of the base layer remains in place in good condition and does not require removing or any preparation or treatment, apart perhaps from cleaning. The use of separable fastenings allows the top layer to be easily and quickly removed from the base layer. This benefit arises from combining the vinyl top layer with the fabric backing layer to form the overall top covering layer.

### ADVANTAGES OF THE PRESENT INVENTION

One of the major advantages of the present invention is that by using the flooring system of the present invention, it is possible to create a free floating modular flooring system that can be installed over any subfloor including wood, concrete, ceramic or vinyl with very little, if any, subfloor preparation other than removal of any loose material or severe levelling defects. By being able to replace the top layer whilst leaving the underlayer intact, the cost of repairing or replacing the floor covering is significantly reduced. In particular, there is no need to apply a levelling layer to the floor or subfloor before the flooring system of the present invention can be used, nor is there a need to treat the floor or base layer before applying the top layer.

After the flooring system of the present invention has been laid, when it is time to refurbish the flooring system by replacing the top layer, one of the advantages of the present invention include being able to replace quickly and easily the upper or top floor covering layer of a floor covering system by merely replacing the top layer without having to replace or treat the base layer or any of the underlying layers. Initially, when laying the floor for the first time, provided the floor is generally level, minimal surface preparation of the floor is required since the free floating floor is laid on top of the existing floor and no significant preparation of the floor is required.

If any individual piece of the floor covering layer is damaged, worn prematurely or requires replacement for one reason or another, it is a simple matter to remove the offending strip or strips and merely relay fresh replacement strips. There is no need to remove or otherwise treat the underlying layers, particularly the base layer, nor is there the need to “pull-up” the remainder of the top layer. Only the damaged or affected part of the top layer need be replaced. The integral backing provided on the strip of vinyl allows the flooring to be repaired in this manner.

As the entire under surface of the upper floor covering layer is provided with a first set of fastening elements and almost the entire upper surface of the base layer is provided with another set of complementary elements, the edges of each individual vinyl strip can be accurately placed in line and level with the edges of adjacent strips so that there are no gaps or cracks between adjacent strips and that the floor presents a substantially continuous uniform surface having the appearance of a timber floor. The cost savings of using the floor covering system of the present invention are considerable.

It is to be understood that, if any prior art publication is referred to herein, such reference does not constitute an admission that the publication forms a part of the common general knowledge in the art, in Australia or any other country.

It will be understood to persons skilled in the art of the invention that many modifications may be made without departing from the spirit and scope of the invention.

1. A floor covering system capable of covering a floor or floor substrate comprising a base layer having a lower surface capable of being located upon the floor, a floor substrate or a subfloor or onto an intermediate layer and a covering layer characterised in that a base layer has a first surface provided with one or more first fastening elements and the covering layer has a first surface provided with one or more second fastening elements wherein the first and second fastening elements are complementary to one another to allow the first surface of the covering layer to be releasably secured to the first surface of the base layer by the cooperative interaction of the first and second fastening elements such that when the covering layer is to be replaced the covering layer is readily removable from the base layer by separating the first and second fastening elements from one another thereby releasing the covering layer from the base layer whilst the base layer remains in situ on the floor, floor substrate, subfloor or intermediate layer.

2. A floor covering system having a simulated appearance capable of covering a floor or floor substrate characterised in that the floor covering material is made at least in part from a vinyl material providing a simulated floor having the appearance of individual elements of a floor and a base layer having a lower surface capapable of being located upon or secured to the floor substrate or to an intermediate layer located between the floor substrate and the base layer wherein the upper surface of the base layer is provided with one part of a fastening system and the lower surface of the covering layer is provided with another part of the fastening system, said one part of the fastening system and the other part of the fastening system being complementary to each other to allow the floor covering layer and base layer to be releasably secured to each other, such that the base layer is locatable between the floor and the covering layer to provide an underlay for the covering layer which underlay is substantially smooth and regular so that when the floor covering layer needs replacement the floor covering layer can be releasably removed from the base layer by separating the releasably securable fastening elements from each other without the base layer being removed from the floor substrate.

3. A removable floor covering layer comprising a first part in the form of a vinyl layer or a layer containing vinyl or a vinyl look-a-like layer or a vinyl substitute layer forming a top surface of the floor covering layer and a second part in the from of a backing layer attached, adhered or in intimate contact with the top surface to form the floor covering layer wherein the backing layer is provided with at least one releasably receivable fastening element for releasably securing the floor covering layer to another layer or part of a floor to allow ready removal of the top covering layer from the other layer or floor when the floor covering layer is to be replaced.

4. A method of covering a floor including the steps of located a base layer on the floor or on an intermediate layer located on the floor characterised in that the base layer has an upper surface provided with at least one first fastening element, locating the covering layer having a lower surface provided with at least one second fastening element upon the base layer wherein the first and second fastening elements cooperatively engage with each other to releasably secure the covering layer to the base layer such that the lower surface of the floor covering layer is releasably fastened to the upper surface of the base layer thereby allowing ready removal of the covering layer from the base layer by separating the releasably securable fastening elements from one another.

5. A method of renovating a floor covering using a floor covering system characterised in that the floor covering system includes a base layer and a floor covering layer in which one surface of the base layer is located upon or securely attached to the floor substrate or to an intermediate layer and the other surface of the base layer is releasably securable to a floor covering layer thereby allowing ready replacement of the covering layer to renovate the floor covering wherein the lower surface of the floor covering layer is provided with a multitude of first fastening elements and the upper surface of the base layer is provided with a second set of fastening elements arranged so that the floor covering layer is releasably securable to the base layer.

6. A floor covering system according to claim 1 characterised in that the floor covering system further includes one or more intermediate layers.

7. A system according to claim 1 characterised in that the base layer is in the form of individual base layer elements or is a modular base layer.

8. A system according to claim 1 characterised in that the base elements are in the form of plates, tiles, squares, panels, rectangles, hexagons, sheets, hook plates, regularly shapes polygons, triangles or similar.

9. A system according to claim 1 characterised in that the base elements are interconnected together or are interlockingly connected together to form the base layer wherein the upper surface of the base elements is provided with the first fastening elements.

10. A system according to claim 1 characterised in that the hook plate cooperatively engages with interlocking elements in the form of discs such that the hook plates are provided with quadrants at or towards each corner of the individual hook plates for receiving the discs to retain the base elements in adjacent interconnected relationship to each other.

11. A system according to claim 1 characterised in that the floor covering layer is in the form of individual cover elements such as plates, tiles, squares, rectangles, elongate strips, simulated timber lengths, sheets, boards, flitches, regular shapes or the like.

12. A system according to claim 1 characterised in that the simulated appearance of the floor covering layer is that of a timber floor, a tiled floor, a cork floor, or the like comprising a number of separate elements such as strips, boards, planks, blocks, flitches or the like representing timber or wood.

13. A system according to claim 1 characterised in that the base elements are rigid or semi rigid plastic tiles.

14. A system according to claim 1 in which the floor covering layer is a vinyl flooring material or a vinyl like flooring material or a vinyl substitute flooring material or similar, preferably a vinyl material simulating a wooden or timber floor.

15. A system according to claim 1 characterised in that the floor covering layer is a vinyl layer or a layer containing vinyl or a vinyl look alike layer or vinyl substitute layer.

16. A system according to claim 1 characterised in that the floor covering layer is provided with an additional layer to the top layer in which the additional layer is a fabric layer or a fabric like layer or a layer acting like a fabric or is of a fibrous nature.

17. A system according to claim 1 characterised in that the fabric layer is provided with the second fastening elements in the form of a multitude of hooks, loops, projections or the like.

18. A system of claim 1 characterised in that the loops of the fabric layer are formed from the fibres making up the fibrous fabric layer.

19. A system of claim 1 characterised in that the fabric layer is a backing layer of the vinyl top covering layer.

20. A system of claim 1 characterised in that the backing layer is connected to, adhered to, in intimate contact with or forms the lower surface of the vinyl top covering layer.

21. A system of claim 1 characterised in that tension is applied to the fabric backing layer when applying the fabric to the covering layer so as to match the backing layer to the top covering layer.

22. A system of claim 1 characterised in that the fabric layer is stretched prior to or applying the fabric backing layer to the top covering layer.

23. A system of claim 1 characterised in that the fabric layer is a poly propylene non-woven layer, optionally including a polyethylene component, preferably as a barrier layer.

24. A system of claim 1 characterised in that the fabric backing layer is a polypropylene non-woven and polyethylene file tricot stitched with polyester yarn to provide protruding loops.

25. A flooring system according to claim 1 characterised in that the first releasably securable fastening elements of the base element are in the form of projections having an enlarged head, tapered side or the like.

26. A system according to claim 1 characterised in that the first fastening elements on the upper surface of the base elements are a plurality of projections arranged in closely packed or closely spaced apart relationship to each other over the upper surface of the base element for engaging the loops so that at least some of the loops engage around the tapering side surface of the projections to secure the top covering layer and base layer together.

27. A system according to claim 1 characterised in that the projections are in the form of small hollow tubes or annuli having a centrally located opening and tapering sides forming an enlarged head with tapering sides for engaging with loops of the floor covering layer.

28-32. (canceled)
